(19) United States
(12) Patent Application Publication
(10) Pub. No.: US 2002/0060154 A1
(43) Pub. Date: May 23, 2002

(54) Isoelectric gateways and method and apparatus for using such isoelectric gateways

(76) Inventor: Gyula Vigh, Magnolia, TX (US)

Correspondence Address: James D. Jacobs, Esq.,, Baker & McKenzie, 805 Third Avenue, New York, NY, 10022, US

(21) Appl. No.: 09/990,549

(22) Filed: Nov. 21, 2001

(30) Foreign Application Priority Data
Nov. 22, 2000 (AU) PR1614

(51) Int. Cl. G01N 27/26; G01N 27/447

(52) U.S. Cl. 204/459; 204/465; 204/548; 204/610; 204/615; 204/644

(57) ABSTRACT

This invention is directed to isoelectric gateways for use in the alteration of the composition of the sample wherein the buffering capacity of such isoelectric gateways is not as limited as in an isoelectric membrane and the isoelectric gateways are suitably used in analytical and preparative-scale isoelectric focusing separations, or in the alteration of the composition of solutions that contain at least one amphoteric substance. The isoelectric gateway is comprised of a first ion-permeable barrier; a second ion-permeable barrier at a predetermined distance apart from the first ion-permeable barrier so as to define a space therebetween; and an isoelectric substance disposed between the first and second ion-permeable barriers, wherein the isoelectric substance has a characteristic pI value and a good buffering capacity and adequate conductivity around its characteristic pI value, and wherein the ion-permeable barriers substantially prevent convective mixing between the contents of the isoelectric gateway and its environment.

### BACKGROUND OF THE INVENTION

This invention is directed to isoelectric gateways which provide the same operational functionality as an isoelectric membrane. Furthermore, the present invention is directed to methods and apparati using isoelectric gateways to achieve analytical and preparative-scale isoelectric focusing (IEF) separations, or alter the composition of solutions that contain at least one amphoteric substance.

The charge state of amphoteric molecules, such as amino acids, oligo- and polypeptides, proteins, etc., which have both weak acid and weak base functional groups, depends on the pH of their environment. By varying the pH of the solution from very acidic to very basic, the charge-state of amphoteric molecules can be changed from cationic to anionic. There is a certain pH value, the isoelectric point (pI value) of the molecule, at which the net charge of the amphoteric molecule is zero. Consequently, if a stable pH gradient is created in a separation chamber in the presence of an electric field, components with different pI values will achieve zero net charge and stop migrating at different positions in the separation compartment, thus get separated from each other. The greater the rate of change in their charge as a function of pH at their pI values, the better the focusing (i.e., the separation). Preferably, the buffer capacities of the components involved in the formation of the pH gradient is high. Buffering capacity is defined as the number of moles of strong electrolyte required to change the pH of a 1 L solution of a species by one pH unit.

There are several ways to create a stable pH gradient. One of the oldest ones relies on the use of carrier ampholytes (e.g., polyamino polycarboxylic acids). If convective mixing in the separation chamber is minimized (by using an anticonvective medium, such as a gel, or a narrow bore open tube), a stable pH gradient can be formed in the electric field from a complex mixture of polyamino polycarboxylic acids. Alternatively, if different binary mixtures of appropriate weak acids and weak bases (Bier's buffers) are fed into the separation chamber such that their lateral convective mixing is prevented, a stepwise pH gradient can be created and essentially preserved for limited periods of time in the electric field. A common drawback of both of these isoelectric focusing separation methods is that the separated analytes are mixed with the components that were used to establish the pH gradient. This drawback can be eliminated by using the autofocusing mode of isoelectric focusing separation, which utilizes the amphiprotic substances of a complex mixture to create their own pH gradient in the electric field during separation.

A significant improvement in isoelectric focusing separations was accomplished by using a multicompartmental isoelectric membrane electrolyzer that was created from a series of isoelectric membranes which were placed between an anodic (low pI) isoelectric membrane and a cathodic (high pI) isoelectric membrane. Under the influence of the electric field, the sample components are trapped between the isoelectric membranes whose pI values bracket the pI value of the sample component. Thus, an isoelectric focusing separation in such unit does not require the presence of electrolyte in addition to the sample component, and the products can be recovered in pure state. A significant drawback of the isoelectric membrane technology is that the total buffering capacity of each membrane is relatively limited.

It is desirable to have another method for creating stable pH gradients wherein the buffering capacity of the system is not as limited as in an isoelectric membrane and the method is suitably used to achieve analytical and preparative-scale isoelectric focusing separations, or alter the composition of solutions that contain at least one amphoteric substance.

### SUMMARY OF THE INVENTION

In accordance with the present invention, there is provided an isoelectric gateway for use in the alteration of the composition of the sample wherein the buffering capacity of the isoelectric gateway is not as limited as in an isoelectric membrane and the isoelectric gateway is suitably used in analytical and preparative-scale isoelectric focusing separations, or in the alteration of the composition of solutions that contain at least one amphoteric substances.

Further, in accordance with the present invention, there is provided an isoelectric gateway comprising: a first ion-permeable barrier; a second ion-permeable barrier at a predetermined distance apart from the first ion-permeable barrier so as to define a space therebetween; and an isoelectric substance disposed between the first and second ion-permeable barriers, wherein the isoelectric substance has a characteristic pI value and a good buffering capacity and adequate conductivity around its characteristic pI value, and wherein the ion-permeable barriers substantially prevent convective mixing between the isoelectric gateway and its environment.

In one embodiment, the isoelectric gateway is suitably used in an apparatus to carry out isoelectric focusing separations. In another embodiment, the isoelectric gateway is suitably used in an apparatus to remove undesirable constituents, such as strong electrolytes, weak electrolytes, neutral components, and/or large molecular weight components or particulates from a solution that contains at least one amphoteric substance. In yet another embodiment, the isoelectric gateway is suitably used to trap certain components in a chamber or plurality of chambers to carry out chemical modifications in at least one of the chambers.

The primary application areas of the isoelectric gateway and the associated methods and apparati are in the separation, purification, enrichment, concentration, conditioning or alteration of both small and large molecular weight compounds, including but not limited to small ampholytic pharmaceuticals (natural and non-natural amino acids, amino phenolics, amino phosphonic acids, etc.), oligo- and polypeptides, proteins, oligonucleotides, and the like. Additional application areas of the isoelectric gateway and associated methods and apparati include the removal of strong and weak electrolytes, amphoteric or otherwise, neutral additives or particulate contaminants from solutions of both small and large molecular weight compounds, amphoteric or otherwise, such as small amphoteric pharmaceuticals (natural and non-natural amino acids, aminophenolics, amino phosphonic acids, etc.), oligo- and polypeptides, proteins, oligonucleotides, and the like.

These applications are suitably achieved based on the use of protic equilibria only, or by a combination of protic and other (e.g., complexation) secondary chemical equilibria or reactions.

Though such operations are suitably achieved by other means, such as via the use of ampholytes, immobilized pH-gradient gels or isoelectric membranes, the methods outlined here offer possibly greater simplicity and higher production rates.

These and other aspects of the present invention will be understood by one of ordinary skill in the art upon the reading and understanding of the specification.

### BRIEF DESCRIPTION OF THE DRAWINGS

FIG. 1 is a schematic representation of an isoelectric gateway according to the present invention.

FIG. 2 is a schematic representation of a system comprising isoelectric gateways according to the present invention.

FIG. 3 is a schematic representation of a separation unit comprising isoelectric gateways according to the present invention.

FIG. 4 is a schematic diagram of the separation unit according to the present invention utilizing the separation unit of FIG. 3.

### DETAILED DESCRIPTION OF THE INVENTION

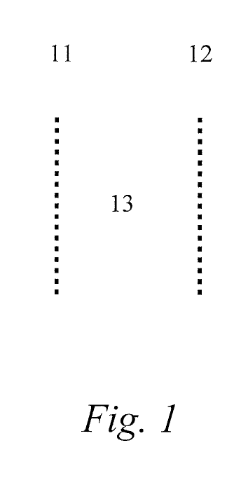

This invention is directed to isoelectric gateways for use in the alteration of the composition of a sample wherein the buffering capacity of the isoelectric gateway is not as limited as in an isoelectric membrane and the isoelectric gateway is suitably used in analytical and preparative-scale isoelectric focusing separations, or in the alteration of the composition of solutions containing at least one amphoteric substances. As shown in FIG. 1, the isoelectric gateway 10 is comprised of a first ion-permeable barrier 11; a second ion-permeable barrier 12 at a predetermined distance apart from the first ion-permeable barrier so as to define a space therebetween; and an isoelectric substance 13 disposed between the first and second ion-permeable barriers, wherein the isoelectric substance has a characteristic pI value and a good buffering capacity and adequate conductivity around its characteristic pI value, and wherein the ion-permeable barriers substantially prevent convective mixing between the contents of the isoelectric gateway and its environment.

The ion-permeable barriers are suitably created by an immiscible liquid, a porous solid such as a frit or a membrane (non-ionic or isoelectric), or a gel (non-ionic or isoelectric). Generally, the ion-permeable barriers that substantially prevent convective mixing between the solutions adjacent to them are non-ionic membranes or porous frits. In one embodiment, the barriers are non-ionic membranes which are unsupported and are comprised of cellulose esters, polysulfones, polyethersulfones, cross-linked polymethylacrylate or the like. In another embodiment, the membranes are non-ionic membranes which are supported and are composed of cross-linked polyacrylamide or agar supported on glass fiber, filter paper, polymeric mesh, or paper. In another embodiment, the barriers are porous frits, such as glass frits, polymeric frits, and the like. In one preferred form, the ion-permeable barriers are made from crosslinked polyacrylamide. Preferably, the distance between the ion-permeable barriers comprising the isoelectric gateway is kept at a minimum to minimize the time needed for a species to travel across the isoelectric gateway under the influence of an electric field.

The two ion-permeable barriers are used to enclose the stagnant or flowing (straight-through or recirculated) solution of the isoelectric material that has sufficient conductivity, buffering and titrating capacity in the vicinity of its characteristic pI value. In a preferred embodiment, the ion-permeable barriers restrict the passage of certain molecules greater than a specified size. Preferably, the ion-permeable barriers substantially prevent pressure-driven or gravity-driven hydraulic flow. Preferably, the ion-permeable barriers are capable of minimizing convective mixing of the isoelectric substance within the ion-permeable barriers and any solution in an adjacent chamber or chambers.

The isoelectric substance located between the ion-permeable barriers is suitably a molecule with appropriate combinations of weak acid and weak base functionalities, weak acid and strong base functionalities, or strong acid and weak base functionalities. For example, suitable isoelectric substances include, but are not limited to, (poly)amino (poly)carboxylic acids, (poly)amino (poly)phenols, (poly)amino (poly)phosphonic acids, (poly)amino (poly)sulfonic acids, (poly)amino (poly)phenol(poly)carboxylic acids, (poly)amino (poly)phenol(poly)phosphonic acids, (poly)amino (poly)carboxylic (poly)phosphonic acids, (poly)amino (poly)phenol(poly)sulfonic acids, (poly)amino (poly)phenol-(poly)carboxylic(poly)sulfonic acids or (poly)amino (poly)phenol(poly)carboxylic-(poly)phosphonic(poly)sulfonic acids, (poly)imino (poly)carboxylic acids, (poly)imino (poly)phenols, (poly)imino (poly)phosphonic acids, (poly)imino (poly)sulfonic acids, (poly)imino (poly)phenol(poly)carboxylic acids, (poly)imino (poly)phenol(poly)phosphonic acids, (poly)imino (poly)carboxylic (poly)-phosphonic acids, (poly)imino (poly)phenol(poly)sulfonic acids, (poly)imino (poly)phenol-(poly)carboxylic(poly)sulfonic acids or (poly)imino (poly)phenol(poly)carboxylic-(poly)phosphonic(poly)sulfonic acids or their combinations. The isoelectric substance has a characteristic pI value and a good buffering capacity and adequate conductivity around its characteristic pI value. Such isoelectric substances have pK values that are less than 2 pH units, preferably less than 1.5 pH units, and even more preferably, less than 1 pH unit away from the pI values they define. The pI value of the isoelectric substance used depends on the application objectives of the isoelectric gateway. Preferably, the isoelectric substance has a pI value ranging from about 1 to about 13.

Preferably, the isoelectric substance is a large molecular weight component. The solution of the amphoteric isoelectric substance can be stationary or flowing (straight-through or recirculated) between the ion-permeable barriers that substantially prevent pressure-driven or gravity-driven hydraulic flow and convective mixing between the interior and exterior of the isoelectric gateway. Preferably, the isoelectric substances in the isoelectric gateways are stationary to minimize the time any substance present in the isoelectric gateway spends outside of the electric field. In another embodiment, the isoelectric substances in the isoelectric gateways are flowing (straight-through or recirculated) to minimize the time any substance present in the isoelectric gateway spends inside the electric field.

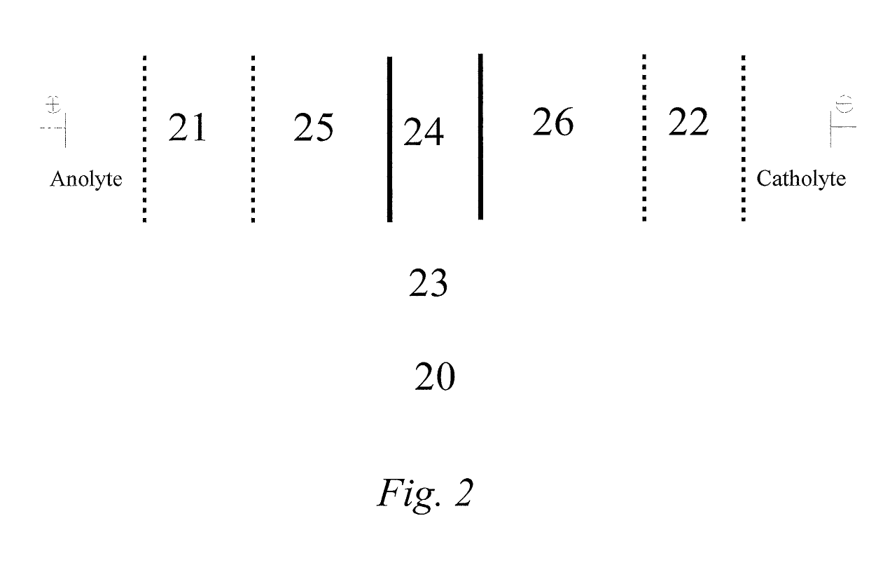

As shown in FIG. 2, in one embodiment, the functional equivalent of an isoelectric focusing apparatus is created by replacing at least one of the isoelectric membranes used in these apparati by the isoelectric gateways of the present invention. For example, the anodic and cathodic isoelectric membranes used in an earlier multicompartmental electrolyzer 20 are suitably replaced by an anodic isoelectric gateway 21 with an effective pI value of PI_{anodic gateway} and a cathodic isoelectric gateway 22 with an effective pI value of PI_{cathodic gateway}. The mixture of ampholytic compound(s) to be processed or separated (sample solution) is placed into the separation chamber 23, between the anodic and cathodic isoelectric gateways. As usual in isoelectric focusing, the anolyte might be an acidic solution with PH_{anolyte}<PI_{anodic gateway}, or an amphiprotic substance solution with a pH_{anolyte}<PI_{anodic gateway}, the catholyte might be a base solution with a PI_{cathodic gateway}<PH_{catholyte} or an amphiprotic substance solution with a PI_{cathodic gateway}<pH_{catholyte}. Any or all of the solutions (anolyte, catholyte, anodic isoelectric gateway solution, cathodic isoelectric gateway solution and sample solution) might be stationary, go through the apparatus in a single pass, go through the apparatus in multiple passes or be recirculated through the apparatus during all or part of the processing steps. Preferably, the isoelectric substances in the isoelectric gateways are stationary to minimize the time any substance present in the isoelectric gateway spends outside of the electric field.

It is understood that in an alternative embodiment, a select one of the anodic or cathodic gateways is replaced with an isoelectric membrane.

The isoelectric focusing separation of the sample components is achieved by placing at least one ion-permeable barrier 24, e.g., a non-electric membrane, a non-electric frit, a non-electric porous substrate, an isoelectric membrane, or an isoelectric gateway into the separation chamber, such that with respect to the positions and/or pI values of the anodic and cathodic isoelectric gateways, the position(s) and/or pI values of the ion-permeable barrier(s) is (are) variable in the 0<L^{anodic gateway}_{barrier}<L^{anodic gateway}_{cathodic gateway} spatial range and the pH_{anolyte}<PI_{anodic gateway}<PI_{barrier}<PI_{cathodic gateway}<PH_{catholyte} range, where L^{anodic gateway}_{barrier} is the distance in the separation chamber between the anodic gateway and the barrier(s), and L^{anodic gateway}_{cathodic gateway} is the distance in the separation chamber between the anodic gateway and the cathodic gateway. The ion-permeable barriers permit the division of the sample into two or more fractions with different effective pI values. In this embodiment, one ion-permeable barrier 24 divides the separation chamber into two separate chambers or fractions 25 and 26. These fractions are suitably further fractionated or processed to create further fractions with higher purity, concentration, different composition or different effective pI values.

Typically, the barrier (located in the separation chamber) used in the isoelectric focusing separation is an isoelectric membrane whose pI value may be adjusted during its preparation, or an isoelectric gateway similar in construction to those used to close off the anode and cathode compartments, wherein the amphoteric, isoelectric medium loaded into such isoelectric gateway has a pI value that can be varied during its preparation.

A single such barrier leads to a binary isoelectric separation, i.e., to a separation where the sample is divided into two fractions: one of the fractions has a lower pI value, the other one a higher pI value. Narrow pI cuts can be obtained by two sequential isoelectric focusing separations using barriers of slightly different pI values and/or slightly different spatial positions.

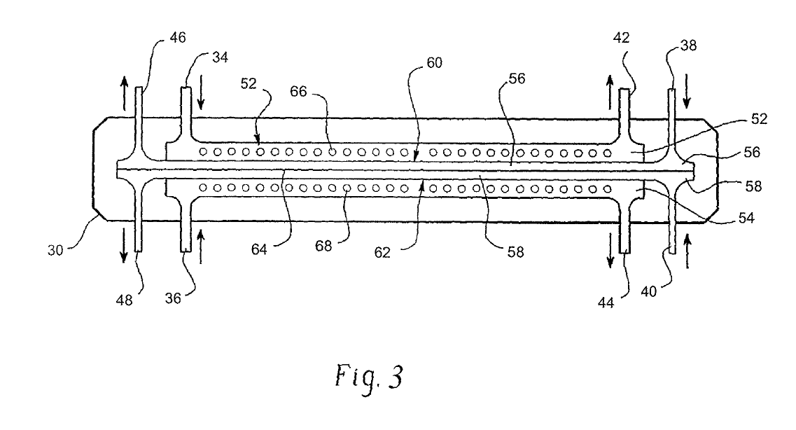

A more detailed example of such an apparatus is shown in FIG. 3. Referring to FIG. 3, a schematic representation of separation unit 30 is shown for the purpose of illustrating the general functionality of a separation device utilizing the technology of the present invention. Separation unit 30 comprises first electrolyte inlet 34, and second electrolyte inlet 36, first sample inlet 38, 30 and second sample inlet 40, first electrolyte outlet 42, and second electrolyte outlet 44, and first sample outlet 46 and second sample outlet 48. Between first electrolyte inlet 34 and first outlet 42 is first electrolyte chamber 52. Likewise, between second electrolyte inlet 36 and second electrolyte outlet 44 is second electrolyte chamber 54. First sample and second sample inlets and outlets also have connecting chambers. First sample chamber 56 running adjacent to first electrolyte chamber 52 connects first sample inlet 38 to first sample outlet 46. Similarly, second sample chamber 58 running adjacent to second electrolyte chamber 54 connects second sample inlet 40 to second sample outlet 48. Isoelectric gateways 60 and 62 separate electrolyte chambers 52 and 54 from first sample and second sample chambers 56 and 58, respectively. In an alternative embodiment, a select one of isoelectric gateways 60 and 62 is suitably replaced with an ion-permeable barrier.

The isoelectric gateways are comprised of a first ion-permeable barrier; a second ion-permeable barrier at a predetermined distance apart from the first ion-permeable barrier so as to define a space therebetween; and an isoelectric substance disposed between the first and second ion-permeable barriers, wherein the isoelectric substance has a characteristic pI value and a good buffering capacity and adequate conductivity around its characteristic pI value, and wherein the ion-permeable barriers substantially prevent convective mixing between the isoelectric gateway and its environment. Preferably, the isoelectric substance has a pI value ranging from about 1 to about 13.

Between first sample and second sample chambers 56 and 58 is ion-permeable barrier 64. In an alternative embodiment, ion-permeable barrier 64 is an isoelectric gateway. It should be understood that during operation, first and second electrolyte 66 and 68, as well as first and second sample 86 and 96 may be stationary in, or flow through, the respective chambers.

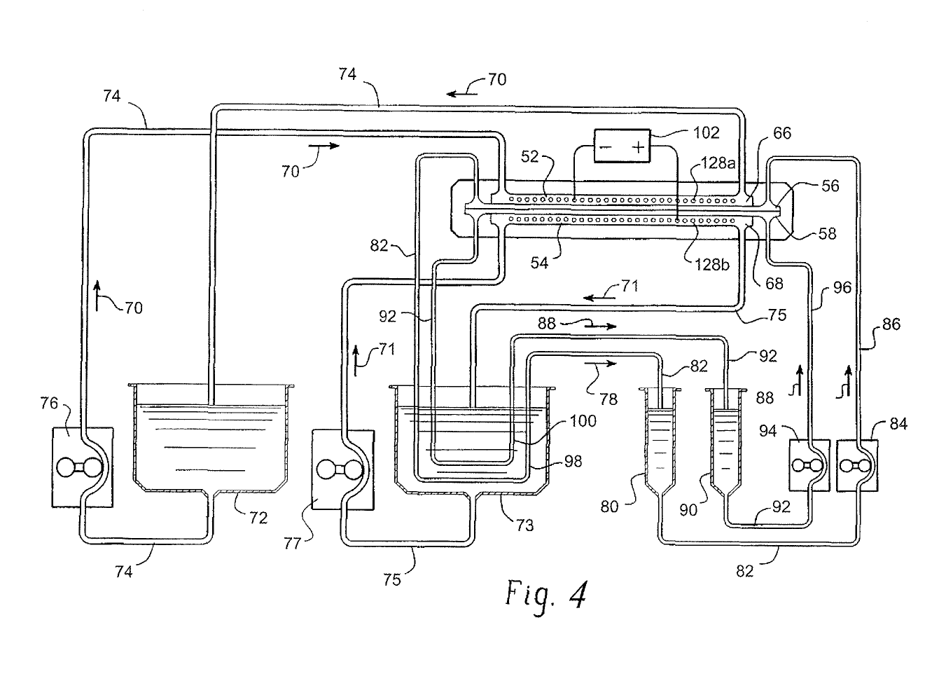

A schematic diagram of an apparatus utilizing separation unit 30 of FIG. 3 is shown in FIG. 4 for the purpose of illustrating the general functionality of an apparatus utilizing the technology of the present invention. In this purely illustrative example, four chambers (first electrolyte chamber 52, second electrolyte chamber 54, first sample chamber 56, and second sample chamber 58) are connected to four flow circuits. First electrolyte flow circuit 70 comprises first electrolyte reservoir 72, electrolyte tubing 74, and electrolyte pump 76. Second electrolyte flow circuit 71 comprises second electrolyte reservoir 73, electrolyte tubing 75, and electrolyte pump 77.

In the embodiment shown, first electrolyte 66 flows from first electrolyte reservoir 72 through tubing 74 to pump 76 to first electrolyte chamber 52. Second electrolyte 54 flows from second electrolyte reservoir 73 through tubing 75 to pump 77 to second electrolyte chamber 54. First electrolyte 66 flows through inlet 34 and second electrolyte 68 flows through inlet 36. First electrolyte 66 exits separation unit 30 through outlet 42 and second electrolyte 68 exits separation unit 30 through outlet 44. After exiting separation unit 30, electrolytes 66 and 68 flow through tubing 74 and 75 back into respective electrolyte reservoirs 72 and 73. In one embodiment, at least one of electrolytes 66 and 68 are held stagnant in electrolyte chambers 52 and 54 during separation.

First sample flow circuit 78 contains first sample reservoir 80, tubing 82 and pump 84. First sample 86 flows from first sample reservoir 80 through tubing 82 to pump 84, then through inlet 38 into first sample chamber 56. In one embodiment, the flow directions of first sample 86 and electrolytes 66 and 68 are opposite. In another embodiment, the flow directions of first sample 86 and electrolytes 66 and 68 are the same. First sample 86 exits separation unit 30 at outlet 46 and flows through tubing 82, then heat exchanger 98 that passes through second electrolyte reservoir 73 before returning to first sample reservoir 80 through tubing 82.

Similarly, second sample flow circuit 88 contains second sample reservoir 90, tubing 92 and pump 94. Second sample 96 flows from second sample reservoir 90 through tubing 92 to pump 94, then through inlet 40 into second sample chamber 58. In one embodiment, the flow directions of second sample 96 and electrolytes 66 and 68 are opposite. In another embodiment, the flow directions of second sample 96 and electrolytes 66 and 68 are the same. Second sample 96 exits separation unit 30 at outlet 48 and flows through tubing 92, then heat exchanger 100 that passes through second electrolyte reservoir 73 before returning to second sample reservoir 90 through tubing 92. In an alternative embodiment, heat exchanger 100 passes through first electrolyte reservoir 73.

The separation unit further comprises electrodes 128a and 128b. Preferably, the respective electrodes are located in the first and second electrolyte chambers and are separated from the first and second sample chambers by ion-permeable barriers. The electrodes are connected to power supply 102 by any suitable means.

Separation unit 30 also preferably comprises electrode connectors 78 that are used for connecting separation unit 2 to power supply 72.

In use, electrolytes are place in the respective electrolyte reservoirs and passed through the electrolyte reservoirs. When used, an isoelectric substance is disposed between the ion-permeable barriers forming each isoelectric gateway and is flowed through or recirculated through the separation unit via a flow circuit (not shown) or is stationary within the isoelectric gateway. Preferably, the isoelectric substances in the isoelectric gateways are stationary to minimize the time any substance present in the isoelectric gateway spends outside of the electric field. A sample containing one or more components is placed in or pass through one of the sample chambers. Upon application of selected electric potential between the electrodes, at least one component is caused to move through at least one ion-permeable barrier.

In one preferred form, the ion-permeable barrier is a membrane having a characteristic average pore size and pore size distribution. In another preferred form, an ion-permeable barrier is an isoelectric membrane having a characteristic pI value. Preferably, the isoelectric membrane has a pI value in a range of about 1 to about 13.

The isoelectric membranes are preferably polyacrylamide membranes that contain acrylamido weak and strong electrolytes to control the pI value of the isoelectric membrane. It will be appreciated, however, that other isoelectric membranes would also be suitable for the present invention.

The temperature of electrolytes, isoelectric solutions and sample solutions in the system is suitably controlled by any suitable cooling/heating means. The system may also be positioned in a controlled-temperature environment to maintain a desired temperature during operation.

The atmosphere in contact with any or all of the electrolytes, isoelectric solutions and sample solutions in the system is suitably controlled by any suitable gas handling system. The system may also be positioned in a controlled chemical composition environment to maintain a desired atmosphere during operation.

The system may have its own power supply or is suitably connected to an external power supply.

In one preferred form, the part of the system which contains the isoelectric gateways and the sample chambers is provided as a cartridge or cassette adapted to be disposed between the anode and cathode chambers.

The distance between the electrodes (anode and cathode) can have an effect on the separation or movement of compounds through the various barriers or interfaces. As the electric field strength has an important effect on the separation, shorter distances between the electrodes are often advantageous.

The isoelectric gateways may be formed as a multilayer or sandwich arrangement. As the electric field strength has an important effect on the separation, the thickness of all elements can have an effect on the separation of the sample components. It has been found in many circumstances that thinner elements are often advantageous.

In the embodiments where the sample and/or isoelectric substances are not stagnant, flow rates of the electrolyte and/or sample solutions through the system can have an influence on the temperature profile in the system and thus, can have an effect on the separation of the sample components.

Field strengths across the system can vary depending on the separation. Typically, field strength can be up to about 1000 V/cm, depending on the configuration of the system, and the composition of the electrolyte and sample solutions used.

The quality of the isoelectric focusing separation of the sample components might be further improved by simultaneously involving, in addition to the protic equilibria, one or more of the sample constituents in additional secondary chemical equilibria, such as complexation, association, affinity interactions, partitioning, adsorption, evaporation, precipitation or reaction steps to create fractions with higher purity, concentration, different composition or different effective pI values.

The quality of the isoelectric separation of the sample components might be further improved by simultaneously involving, in addition to the protic equilibria and/or additional secondary chemical equilibria, one or more of the sample constituents in additional size or mobility-dependent separation steps to create fractions with higher purity, concentration, different composition or different effective pI values.

By implementing the isoelectric membrane in a size-exclusion membrane matrix, simultaneous size-based and pI-based separations could be obtained.

By using additives, such as cyclodextrins, simultaneous secondary chemical equilibria can be implemented along with the protic equilibria leading to improved separations and/or new kinds of separations, such as enantiomer or positional isomer separations.

By using this invention, fast separations can be obtained with relatively low applied potentials, because the distances between the electrode compartments are short. The surface area of the ion-permeable barriers can be easily increased to increase production rate.

The invention has been described herein by way of example only. It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive. Other features and aspects of this invention will be appreciated by those skilled in the art upon reading and comprehending this disclosure. Such features, aspects, and expected variations and modifications of the reported results and examples are clearly within the scope of the invention where the invention is limited solely by the scope of the following claims.

What is claimed is:

1. An isoelectric gateway for use in the alteration of the composition of a sample, the isoelectric gateway comprising:
a first ion-permeable barrier;
a second ion-permeable barrier at a predetermined distance apart from the first ion-permeable barrier so as to define a space therebetween; and
an isoelectric substance disposed between the first and second ion-permeable barriers, wherein the isoelectric substance has a characteristic pI value and a good buffering capacity and adequate conductivity around its characteristic pI value, and wherein the ion-permeable barriers substantially prevent convective mixing between the isoelectric gateway and its environment.

2. The isoelectric gateway according to claim 1 wherein the isoelectric gateway is substantially functionally equivalent to an isoelectric membrane.

3. The isoelectric gateway according to claim 1 wherein the ion-permeable barriers substantially prevent mixing between the isoelectric gateway and its environment.

4. The isoelectric gateway according to claim 1 wherein the ion-permeable barriers are selected from the group consisting of immiscible liquids, porous solids, non-ionic membranes, isoelectric membranes, non-ionic gels, and isoelectric gels.

5. The isoelectric gateway according to claim 4 wherein the ion-permeable barriers are non-ionic membranes.

6. The isoelectric gateway according to claim 5 wherein the non-ionic membranes are unsupported membranes selected from the group consisting of cellulose esters, polysulfones, polyethersulfones and cross-linked polymethylacrylate.

7. The isoelectric gateway according to claim 5 wherein the non-ionic membranes are supported membranes selected from the group consisting of cross-linked polyacrylamide and agar supported on glass fiber, filter paper, polymeric mesh, and paper.

8. The isoelectric gateway according to claim 4 wherein the ion-permeable barriers are porous frits selected from the group consisting of glass frits, ceramic frits and polymeric frits.

9. The isoelectric gateway according to claim 1 wherein the ion-permeable barriers substantially restrict the passage of molecules having a mass greater than a predetermined size.

10. The isoelectric gateway according to claim 1 wherein the isoelectric substance is selected from the group consisting of substances containing a combination of weak acid and weak base functionalities, substances containing a combination of weak acid and strong base functionalities, and substances containing a combination of strong acid and weak base functionalities.

11. The isoelectric gateway according to claim 1 wherein the isoelectric substance is selected from the group consisting of (poly)amino (poly)carboxylic acids, (poly)amino (poly)phenols, (poly)amino (poly)phosphonic acids, (poly)amino (poly)sulfonic acids, (poly)amino (poly)phenol(poly)carboxylic acids, (poly)amino (poly)phenol(poly)phosphonic acids, (poly)amino (poly)carboxylic (poly)-phosphonic acids, (poly)amino (poly)phenol(poly)sulfonic acids, (poly)amino (poly)phenol-(poly)carboxylic(poly)sulfonic acids or (poly)amino (poly)phenol(poly)carboxylic-(poly)phosphonic(poly)sulfonic acids, (poly)imino (poly)carboxylic acids, (poly)imino (poly)phenols, (poly)imino (poly)phosphonic acids, (poly)imino (poly)sulfonic acids, (poly)imino (poly)phenol(poly)carboxylic acids, (poly)imino (poly)phenol(poly)phosphonic acids, (poly)imino (poly)carboxylic (poly)-phosphonic acids, (poly)imino (poly)phenol(poly)sulfonic acids, (poly)imino (poly)phenol-(poly)carboxylic(poly)sulfonic acids or (poly)imino (poly)phenol(poly)carboxylic-(poly)phosphonic(poly)sulfonic acids and combinations thereof.

12. The isoelectric gateway according to claim 1 wherein the isoelectric substance has a pI value ranging from about 1 to about 13.

13. The isoelectric gateway according to claim 1 wherein the isoelectric substance is a select one of stationary within the ion-permeable barriers, flowing through the ion-permeable barriers, and recirculated through the ion-permeable barriers.

14. The isoelectric gateway according to claim 1 wherein the isoelectric substance remains substantially stationary within the ion-permeable barriers.

15. A method for altering the composition of a sample comprising:
communicating an isoelectric substance disposed between a first ion-permeable barrier and a second ion-permeable barrier to form an isoelectric gateway, wherein the isoelectric substance has a characteristic pI value and a good buffering capacity and adequate conductivity around its characteristic pI value, and wherein the ion-permeable barriers substantially prevent convective mixing between the isoelectric gateway and its environment; and
applying a selected electric potential across associated electrodes positioned on opposing sides of the isoelectric gateway to causes migration of at least one component through at least one of the ion-permeable barriers.

16. An electrophoresis system for isoelectric focusing comprising:
a first electrolyte chamber containing a first electrode;
a second electrolyte chamber containing a second electrode, wherein the second electrolyte chamber is disposed relative to the first electrolyte chamber so that the electrodes are adapted to generate an electric field in an electric field area upon application of a selected electric potential between the electrodes;
a first sample chamber disposed between the first and second electrolyte chambers and proximate to the first electrolyte chamber so as to be at least partially disposed in the electric field area;
a second sample chamber disposed between the first sample chamber and the second electrolyte chamber so as to be at least partially disposed in the electric field area;
a first isoelectric gateway separating the first electrolyte chamber and the first sample chamber, wherein the first isoelectric gateway is comprised of a first ion-permeable barrier, a second ion-permeable barrier at a predetermined distance apart from the first ion-permeable barrier so as to define a space therebetween, and a first isoelectric substance disposed between the first and second ion-permeable barriers, wherein the first isoelectric substance has a characteristic pI value and a good buffering capacity and adequate conductivity around its characteristic pI value, and wherein the first and second ion-permeable barriers substantially prevent convective mixing of the contents of the first isoelectric gateway, the first sample chamber and the first electrolyte chamber;
a first selective barrier separating the first and second sample chambers so as to impede convective mixing between the contents of the first and second sample chambers;
a second selective barrier separating the second sample chamber from the second electrolyte chamber so as to impede convective mixing between the contents of the second sample chamber and second electrolyte chamber;
means adapted for communicating an associated first electrolyte to the first electrolyte chamber;
means adapted for communicating an associated second electrolyte to the second electrolyte chamber, wherein the pH values of associated first and second electrolytes are different;
means adapted for communicating a first fluid to the first sample chamber; and
means adapted for communicating a second fluid to the second sample chamber, wherein at least one of the first and second fluids contains at least a sample; and
means adapted for applying a selected electric potential wherein application of the selected electric potential causes migration of at least one component through at least one of the ion permeable barriers.

17. The electrophoresis system according to claim 16 wherein a pH gradient is formed between the electrodes.

18. The electrophoresis system according to claim 16 wherein the first selective barrier is a second isoelectric gateway which separates the first and second sample chambers, wherein the second isoelectric gateway is comprised of a third ion-permeable barrier, a fourth ion-permeable barrier at a predetermined distance apart from the third ion-permeable barrier so as to define a space therebetween, and a second isoelectric substance disposed between the third and fourth ion-permeable barriers, wherein the second isoelectric substance has a characteristic pI value and a good buffering capacity and adequate conductivity around its characteristic pI value, and wherein the third and fourth ion-permeable barriers substantially prevent convective mixing between the contents of the second isoelectric gateway, the first sample chamber, and the second sample chamber.

19. The electrophoresis system according to claim 16 wherein the second selective barrier is a second isoelectric gateway which separates the second sample chamber from the second electrolyte chamber, wherein the second isoelectric gateway is comprised of a third ion-permeable barrier, a fourth ion-permeable barrier at a predetermined distance apart from the third ion-permeable barrier so as to define a space therebetween, and a second isoelectric substance disposed between the third and fourth ion-permeable barriers, wherein the second isoelectric substance has a characteristic pI value and a good buffering capacity and adequate conductivity around its characteristic pI value, and wherein the third and fourth ion-permeable barriers substantially prevent convective mixing between the contents of the second isoelectric gateway, the second sample chamber, and the second electrolyte chamber.

20. The electrophoresis system according to claim 16 wherein
the first selective barrier is a second isoelectric gateway which separates the first and second sample chambers, wherein the second isoelectric gateway is comprised of a third ion-permeable barrier, a fourth ion-permeable barrier at a predetermined distance apart from the third ion-permeable barrier so as to define a space therebetween, and a second isoelectric substance disposed between the third and fourth ion-permeable barriers, wherein the second isoelectric substance has a characteristic pI value and a good buffering capacity and adequate conductivity around its characteristic pI value, and wherein the third and fourth ion-permeable barriers substantially prevent convective mixing between the contents of the second isoelectric gateway, the first sample chamber, and the second sample chamber; and
the second selective barrier is a third isoelectric gateway which separates the second sample chamber from the second electrolyte chamber, wherein the third isoelectric gateway is comprised of a fifth ion-permeable barrier, a sixth ion-permeable barrier at a predetermined distance apart from the fifth ion-permeable barrier so as to define a space therebetween, and a third isoelectric substance disposed between the fifth and sixth ion-permeable barriers, wherein the third isoelectric substance has a characteristic pI value and a good buffering capacity and adequate conductivity around its characteristic pI value, and wherein the fifth and sixth ion-permeable barriers substantially prevent convective mixing between the contents of the third isoelectric gateway, the second sample chamber, and the second electrolyte chamber.

21. A method for isoelectric focusing comprising:
communicating a first electrolyte to a first electrolyte chamber containing a first electrode;
communicating a second electrolyte to a second electrolyte chamber containing a second electrode, wherein the second electrolyte chamber is disposed relative to the first electrolyte chamber so that the electrodes are adapted to generate an electric field in an electric field area upon application of a selected electric potential between the electrodes;
communicating a first fluid to a first sample chamber disposed between the first and second electrolyte chambers and proximate to the first electrolyte chamber so as to be at least partially disposed in the electric field area;
communicating a second fluid to a second sample chamber disposed between the first sample chamber and the second electrolyte chamber so as to be at least partially disposed in the electric field area, wherein a first isoelectric gateway separates the first electrolyte chamber and the first sample chamber, wherein the first isoelectric gateway is comprised of a first ion-permeable barrier, a second ion-permeable barrier at a predetermined distance apart from the first ion-permeable barrier so as to define a space therebetween, and a first isoelectric substance disposed between the first and second ion-permeable barriers, wherein the first isoelectric substance has a characteristic pI value and a good buffering capacity and adequate conductivity around its characteristic pI value, and wherein the first and second ion-permeable barriers substantially prevent convective mixing between the contents of the first isoelectric gateway, the first sample chamber and the first electrolyte chamber, a first selective barrier separates the first and second sample chambers so as to impede convective mixing between the contents of the first and second sample chambers, and a second selective barrier separates the second sample chamber and the second electrolyte chamber so as to impede convective mixing between the contents of the second sample chamber and the second electrolyte chamber, wherein at least one of the first and second fluids contains a sample; and
applying the selected electric potential to cause migration of at least one selected component through at least one ion permeable barrier.

22. The method according to claim 21 wherein a pH gradient is formed between the electrodes.

23. The method according to claim 21 wherein the first selective barrier is a second isoelectric gateway which separates the first and second sample chambers, wherein the second isoelectric gateway is comprised of a third ion-permeable barrier, a fourth ion-permeable barrier at a predetermined distance apart from the third ion-permeable barrier so as to define a space therebetween, and a second isoelectric substance disposed between the third and fourth ion-permeable barriers, wherein the second isoelectric substance has a characteristic pI value and a good buffering capacity and adequate conductivity around its characteristic pI value, and wherein the third and fourth ion-permeable barriers substantially prevent convective mixing between the contents of the second isoelectric gateway, the first sample chamber, and the second sample chamber.

24. The method according to claim 21 wherein the second selective barrier is a second isoelectric gateway which separates the second sample chamber from the second electrolyte chamber, wherein the second isoelectric gateway is comprised of a third ion-permeable barrier, a fourth ion-permeable barrier at a predetermined distance apart from the third ion-permeable barrier so as to define a space therebetween, and a second isoelectric substance disposed between the third and fourth ion-permeable barriers, wherein the second isoelectric substance has a characteristic pI value and a good buffering capacity and adequate conductivity around its characteristic pI value, and wherein the third and fourth ion-permeable barriers substantially prevent convective mixing between the contents of the second isoelectric gateway, the second sample chamber, and the second electrolyte chamber.

25. The method according to claim 21 wherein
the first selective barrier is a second isoelectric gateway which separates the first and second sample chambers, wherein the second isoelectric gateway is comprised of a third ion-permeable barrier, a fourth ion-permeable barrier at a predetermined distance apart from the third ion-permeable barrier so as to define a space therebetween, and a second isoelectric substance disposed between the third and fourth ion-permeable barriers, wherein the second isoelectric substance has a characteristic pI value and a good buffering capacity and adequate conductivity around its characteristic pI value, and wherein the third and fourth ion-permeable barriers substantially prevent convective mixing between the contents of the second isoelectric gateway, the first sample chamber, and the second sample chamber; and
the second selective barrier is a third isoelectric gateway which separates the second sample chamber from the second electrolyte chamber, wherein the third isoelectric gateway is comprised of a fifth ion-permeable barrier, a sixth ion-permeable barrier at a predetermined distance apart from the fifth ion-permeable barrier so as to define a space therebetween, and a third isoelectric substance disposed between the fifth and sixth ion-permeable barriers, wherein the third isoelectric substance has a characteristic pI value and a good buffering capacity and adequate conductivity around its characteristic pI value, and wherein the fifth and sixth ion-permeable barriers substantially prevent convective mixing between the contents of the third isoelectric gateway, the second sample chamber, and the second electrolyte chamber.
